(19) United States
(12) Patent Application Publication
(10) Pub. No.: US 2012/0105319 A1
(43) Pub. Date: May 3, 2012

(54) DEVICE FOR INPUT OF SIGNS, COMPRISING A BASE ZONE AND AT LEAST TWO PERIPHERAL ZONES, PROCESS AND PROGRAM THEREOF

(76) Inventors: Volker SCHLUE, Cambridge (GB); Michael FESTER, Paris (FR)

(21) Appl. No.: 12/971,447

(22) Filed: Dec. 17, 2010

(30) Foreign Application Priority Data
Oct. 29, 2010 (FR) 1058945

(51) Int. Cl. G06F 3/033

(52) U.S. Cl. 345/157

(57) ABSTRACT

The present disclosure relates to device for inputting at least one sign, including means for moving a cursor/pointer implemented by a user in an input space, and means for interpreting said movements in order to associate sets of movements with corresponding signs, wherein the input space comprises a base zone and at least two peripheral zones. The input method includes:—a step for moving the cursor/pointer from the base zone to a first peripheral zone,—a step for moving the cursor/pointer from said first peripheral zone to a last peripheral zone,—a step for moving the cursor/pointer from said last peripheral zone to said base zone. The method is preferably implemented by a computer program such as a smartphone application.

### TECHNICAL FIELD OF THE INVENTION

The invention relates to the field of methods inputting text, and in particular, into portable devices such as telephones.

At the present time, mobile telephones are widely used, and in particular for sending SMS or e-mail messages, for accessing social networks or for Internet browsing.

In this context, text must be input on keypads which are unsuitable for the available surface area on the devices used. As a matter of fact, it is then necessary to reduce the size of the keypad keys and/or increase the size of the devices, or provide several letters corresponding to single keys. In addition, it is important that the input be sufficiently rapid to ensure proper use of such devices.

### PRIOR ART

Numerous devices have attempted to mitigate the aforementioned difficulties. Thus, from the document WO 2010/010350, a method and a system is known for inputting data, which is based on a touch-sensitive keypad having several keys on a touch screen comprising three separate zones. “Touch-slide” type movements can be carried out between two keys or between two zones, so as to input pre-assigned words or phrases. This device does not appear to be sufficiently satisfactory because it comprises a significant number of keys. Furthermore, the input of words not assigned to movements remains consistent with the prior art.

From the document US 2009/0243897, a method and a device are likewise known for inputting alphabetical or numeric characters on a device having a touch-sensitive surface. The surface comprises nine touch-sensitive buttons each comprising a base and two branches. By tapping on a base, a frequent character in the user's language can be input, and by tapping on this base and sliding onto a branch, the other characters can be input. Such a method, however, remains based on a significant number of buttons and a coding of the characters which is complex and difficult to retain.

A method and a device for inputting data are also known from the document WO 2007/093057, which are based on a touch-sensitive surface divided into three separate zones in which characters are input either by touching nine base zones of the keypad, or by touching these zones and performing 2 long and short longitudinal movements. Such a method proves difficult to use and is based on a complex and difficult to retain coding of the characters.

From the document U.S. Pat. No. 6,031,525, is known a method and apparatus for writing based on a writing mechanism moveable on a tablet surface, and a computer processor which identifies a writeable character from the motion of the writing mechanism from a resting zone into an other zone of a plurality of zones when the writing mechanism is in contact with the surface. Such a method, however, remains based on too many other zones which lead to a slowness in writing when using these method and apparatus.

### DISCLOSURE OF THE INVENTION

The invention aims to remedy the disadvantages of the prior art and, in particular, to propose a simpler system enabling sufficiently rapid input.

To that end, the object of the invention is a device for inputting at least one sign, comprising means for moving a cursor/pointer implemented by a user in an input space, and means for interpreting said movements in order to associate sets of movements with corresponding signs, wherein the input space comprises a base zone and from two to seven peripheral zones.

The input space preferably comprises from three to seven peripheral zones, and advantageously four peripheral zones.

The peripheral zones advantageously extend around the base zone.

The peripheral zones are preferably separated and optionally adjacent to the base zone and/or to one another.

The input space advantageously comprises a touch-sensitive surface provided on and/or connected to said device, and the means for moving a cursor/pointer are implemented on said touch-sensitive surface.

The interpreting means advantageously comprise sign coding wherein each sign is associated with a set of specific movements, and the coding is configured for rapid input.

The device preferably further comprises means for displaying the sign coding and/or means for displaying the sign being input during said movement of the cursor/pointer.

The device according to the invention is either a device comprising a movement sensor such as the controls for certain video games, or a device comprising a touch-sensitive surface and/or a control lever such as a telephone, a multimedia tablet, an organizer, a remote control or a video game joystick.

The object of the invention is likewise a method of inputting at least one sign, comprising steps for moving a cursor/pointer implemented by a user in an input space, and steps for interpreting said movements in order to associate sets of movements with corresponding signs, wherein the input space comprises a base zone and at least two peripheral zones, and in that the inputting of each sign comprises: a step for moving the cursor/pointer from the base zone to a first peripheral zone, a step for moving the cursor/pointer from said first peripheral zone to a last peripheral zone, a step for moving the cursor/pointer from said last peripheral zone to said base zone.

The method according to the invention is advantageously implemented on a device as described above.

The steps for moving a cursor/pointer are preferably implemented on a touch-sensitive surface, however they can be implemented remotely; the moving means then comprise a motion sensor.

The input space preferably comprises at least three peripheral zones, and for inputting certain signs, the step for moving the cursor/pointer from said first peripheral zone to a last peripheral zone occurs through at least one intermediate peripheral zone.

The steps for moving the cursor/pointer are preferably carried out in a substantially circular manner, either in the clockwise direction or in the counter-clockwise direction.

When the method is implemented on a touch-sensitive surface, the inputting of several signs is advantageously carried out by contact with and several movements on the touch-sensitive surface.

When the method is implemented on a touch-sensitive surface, inputting a space after inputting a sign is advantageously carried out by releasing the touch-sensitive surface after said inputting of a sign.

The invention likewise has the object of a computer program product designed to be loaded into the memory of a computer or a device as described above, and comprising software code portions for carrying out the above-described method.

### BRIEF DESCRIPTION OF THE FIGURES

Other characteristics, details and advantages of the invention will emerge upon reading the following description, with reference to the appended figures, which show:

FIG. 1A, a general diagram of an input space, comprising movements of the method according to a preferred embodiment of the invention corresponding to the input of a sign “a”;

FIG. 1B, a general diagram of the method according to a preferred embodiment of the invention;

FIG. 1C, a diagram of movements of the method according to a preferred embodiment of the invention corresponding to the input of the word “you”;

FIG. 2, a diagram of a mobile device comprising a touch screen enabling the method according to a preferred embodiment of the invention to be implemented;

FIG. 3, a diagram of a mobile device comprising a touch-sensitive surface enabling the method according to a preferred embodiment of the invention;

FIG. 4, a diagram of a mobile device comprising a numeric keypad and a touch-sensitive mouse enabling the method according to a preferred embodiment of the invention;

FIG. 5, a diagram of a mobile device comprising a numeric keypad and a roller ball mouse enabling the method according to a preferred embodiment of the invention;

FIG. 6, a diagram of a control device comprising a control lever and associated with a screen.

### DETAILED DESCRIPTION OF EMBODIMENTS

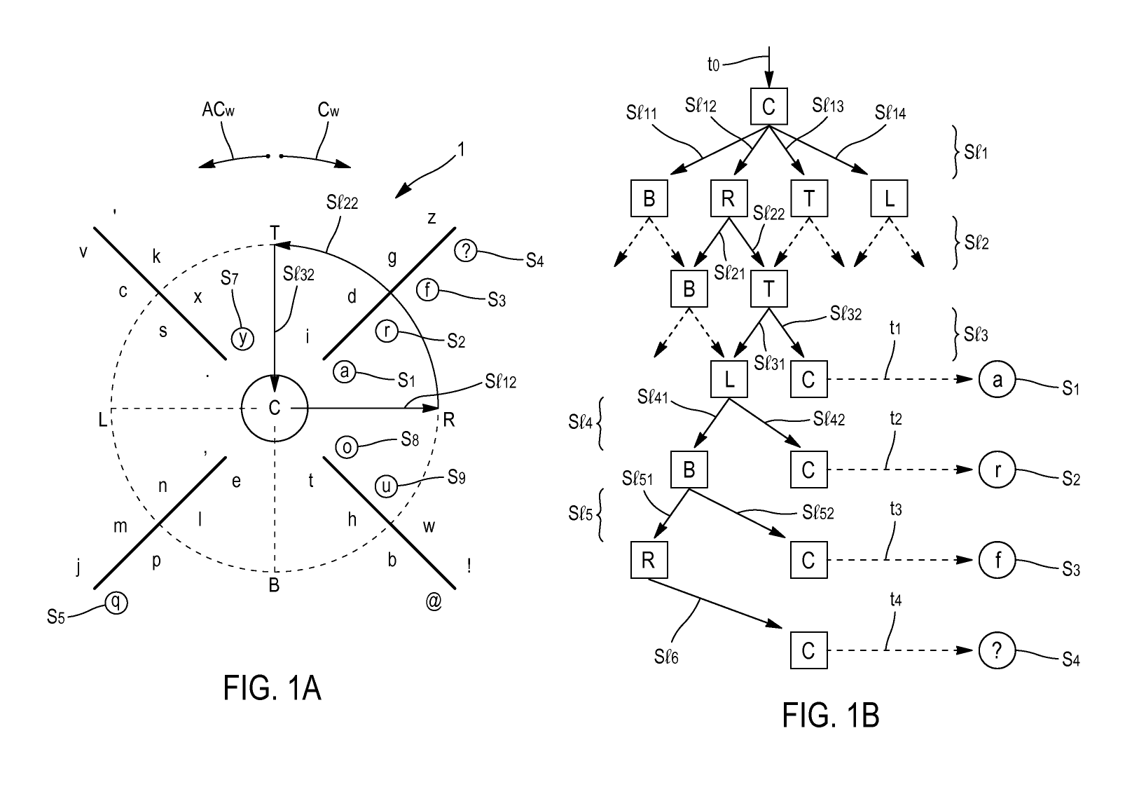

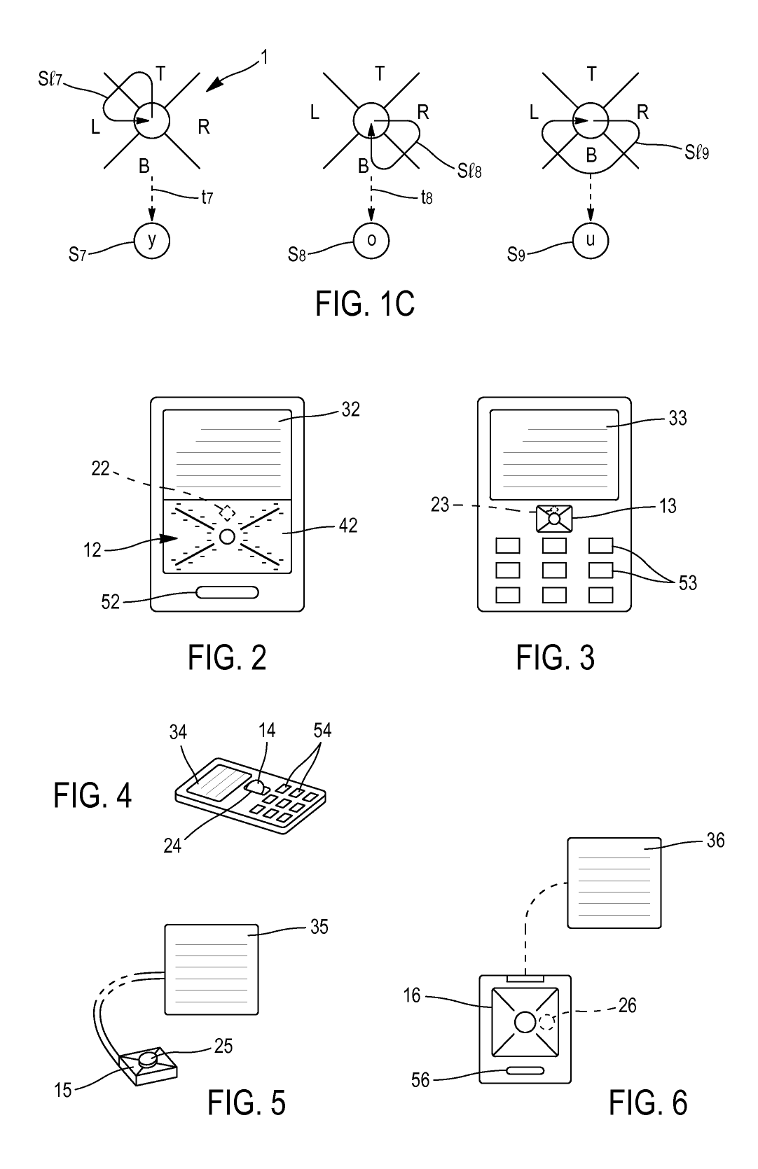

Referring to FIG. 1A, the method according to the invention can be implemented in an input space 1, which can be a three-dimensional volume in which the movements of a cursor/pointer are implemented by movements of a user captured by an appropriately configured device. The input space can also be substantially two-dimensional and remote from the device.

The method is preferably implemented on a touch-sensitive surface which can be a touch screen of a mobile telephone.

The input space is divided into a central base zone C and four peripheral zones: right R, left L, top T or bottom B. The reference Cw indicates a clockwise direction of rotation, and ACw a counterclockwise direction of rotation.

As can be seen in FIG. 1A, the input space is divided into a central base zone C, and four peripheral zones: right R, left L, top T or bottom B. The user can advantageously activate a display of the sign coding in order to take one's bearings while inputting. An exemplary code is shown and optimized for inputting as fast as possible in the English language.

In this example, each letter is displayed in an zone corresponding to the first peripheral zone to be actuated for inputting said letter, on an edge corresponding to a direction of rotation between peripheral zones and in an order corresponding to a number of peripheral zones to be actuated after the first peripheral zone. For example, the letter “a” is displayed in zone R, in the first row and on the counterclockwise side: the input of the letter “a” (sign S1) is carried out by touching the base zone and by sliding -S112- into the right peripheral zone R, then sliding -S112- in the counterclockwise direction towards the top peripheral zone T, and finally by sliding -S112- towards the base zone C. In other words, the first row corresponds to movements between two peripheral zones; the second row, between three peripheral zones; the third row, between four peripheral zones; the fourth row, between five peripheral zones. In the case of the signs of the fourth row, the movements between the peripheral zones consist substantially of one complete rotation. For example, the inputting of letter “q” (sign S5 displayed in zone B, in the fourth row and on the clockwise side) is carried out by touching the base zone and by sliding into zone B, then by successively sliding in the clockwise direction towards zones L, T and R, and by sliding from zone R towards zone B before sliding towards the base zone C.

Thus, each letter displayed is associated with a signature of the type “C-1^{st} PZ-n^{th} PZ-last PZ-C” (where n is 0, 1, 2 or 3 and ZP designates a peripheral zone R, T, L or B).

Referring to FIGS. 1A and 1B, the method according to a preferred embodiment of the invention generally begins with a contact t0 on the central zone C, and first movement S11 towards a first right R, left l, top T or bottom B peripheral zone. The method continues with a second movement S12 from the first peripheral zone (e.g., R) towards a second peripheral zone, either in the clockwise direction -Cw- or in the counterclockwise direction -Acw-, as in the example shown. The third movement is either a return -S132- to zone C for inputting -t1- a sign of the first row (e.g., the sign S1), or a slide -S131- towards the next peripheral zone (zone L in this case), in the same direction of rotation. In the case where the user has not returned to zone C, the fourth movement is either a return -S142- to zone C for inputting -t2- a sign of the second row (e.g., the sign S2), or a slide -S141- towards the next peripheral zone (zone B in this case), in the same direction of rotation. In the case where the user has not returned to zone C, the fifth movement is either a return -5152- to zone C for inputting -t3- a sign of the third row (e.g., the sign S3) or a slide -S151- towards the next peripheral zone (zone R in this case), in the same direction of rotation. In the case where the user has not returned to zone C, the sixth movement is a return -S16- to zone C for inputting -t4- a sign of the fourth row (e.g., the sign S4). Similarly, it is possible to input all of the other signs displayed and shown in FIG. 1A.

Referring to FIG. 1C, inputting the word “you” is carried out by touching the base zone, and by successively making a substantially circular figure -S17- in the counterclockwise direction, a substantially circular figure -S18- in the clockwise direction and another substantially circular figure -S19- in the clockwise direction. The method according to the invention therefore enables texts to be input by making circular figures, figures of the “8” or “∞” type, which, for inputting signs, proves very easy to do in actual practice. Furthermore, the device for implementing the method according to a preferred embodiment is configured such that the inputting of words is carried out by a single contact and several movements, and “spaces” are made by releasing the touch-sensitive surface. The applicant noticed that the regular user achieves a higher input speed than that of the devices with a “Qwerty” type keyboard.

The advantage of the device and method according to the invention lies in the “∞” figures, which increase the inputting speed, mimic handwriting in several languages and reduce inputting errors considerably.

In addition, inputting can be carried out without looking at the keypad, since the central zone is the only real place marker required.

The method according to the invention is preferably implemented in a device comprising a computer program which is either configured during the manufacture of said device or loaded onto the device by means of a computer program product, directly or by means of a computer. For example, such a computer program is configured like an application capable of being loaded onto a mobile telephone by means of a multimedia server to which said mobile telephone is connected. This type of application loading is known per se in the prior art, in particular in servers such as the “AppStore®” or the “Android® Market”.

Referring to FIG. 2, the device according to a preferred embodiment of the invention is a mobile device comprising a touch screen 12 such as a GPS-type device or preferably a mobile telephone. When a text is being input, the touch screen 12 is divided into a text display 32 and an input space which, in this case, is an input surface 42. The input surface 42 occupies a smaller area in comparison to the text display 32, which is advantageous in comparison with known touch-sensitive devices.

Inputting is carried out in this case by the movement of a cursor embodied by the contact of a finger 22 of the user on the input surface 42. One or more buttons 52 are optionally provided on the device, e.g., for performing input-related actions, such as a click or validation of the cursor position.

Referring to FIG. 3, the device according to another embodiment of the invention is a mobile device comprising a touch-sensitive surface such as a mobile telephone comprising a touch-sensitive mouse 13. The touch-sensitive mouse 13 is configured to implement the above-described method.

Inputting is carried out in this case by the movement of a cursor embodied by the contact of a finger 23 of the user on the touch-sensitive mouse 13. One or more buttons 53 are optionally provided on the device, e.g., for inputting numeric characters.

Referring to FIG. 4, the device according to another embodiment of the invention is a mobile device comprising a mouse, such as a mobile phone comprising a ball-mouse 14. When the mouse is in input mode, the movements of the mouse 14 are configured to implement the above-described method.

Inputting is carried out in this case by the movement of a pointer actuated by the ball-mouse 14 under the movements of a finger of the user. One or more buttons 54 are optionally provided on the device, e.g., for inputting numeric characters.

Referring to FIG. 5, the device according to another embodiment of the invention is a control lever 25 actuated in an input space 15, such as a GPS device built into some automobiles. This type of device comprises preferably wireless means for connecting to a screen enabling text display 35. These connection means are known per se by a person skilled in the art.

Inputting is carried out here by the movement of the control lever 25 in the input space 15. One or more buttons (not shown) are optionally provided on the device, e.g., for performing input-related actions such as a click or validation of the cursor position.

Referring to FIG. 6, the device according to another embodiment of the invention is a mobile device comprising a touch-sensitive surface 16, such as a remote control or a video game joystick. This type of device comprises wired or wireless, direct or indirect means for connecting to a screen enabling text display 36. These connection means are known per se by a person skilled in the art.

Inputting is carried out in this case by the movement of a cursor embodied by the contact of a finger 26 of the user on the touch-sensitive surface 16. One or more buttons 56 are optionally provided on the device, e.g., for performing input-related actions such as a click or validation of the cursor position.

Numerous combinations may be anticipated without departing from the scope of the invention; a person skilled in the art will choose one or another based on the economic, ergonomic or dimensional constraints or the like with which they must comply.

1. A device for inputting at least one sign, comprising means for moving a cursor/pointer implemented by a user in an input space, and means for interpreting said movements in order to associate sets of movements with corresponding signs, wherein the input space comprises a base zone and from two to seven peripheral zones.

2. The input device of claim 1, wherein the input space comprises four peripheral zones which extend around the base zone.

3. The input device of claim 1, wherein the peripheral zones are separated and adjacent to the base zone and/or to one another.

4. The input device of claim 1, wherein the input space comprises a touch-sensitive surface linked to said device, and the means for moving a cursor/pointer are implemented on said touch-sensitive surface.

5. The input device of claim 4, wherein the touch-sensitive surface is provided on said device.

6. The input device of claim 1, wherein the interpreting means comprise a sign coding wherein each sign is associated with a given set of movements, and the coding is configured for rapid input.

7. The input device of claim 6. wherein the sign coding comprises sets of signs wherein each sign is in a peripheral zone corresponding to a first peripheral zone to be actuated for inputting said sign, on an edge corresponding to a direction of rotation between peripheral zones and in an order corresponding to a number of peripheral zones to be actuated after the first peripheral zone.

8. The input device of claim 6, wherein the device further comprises means for displaying the sign coding.

9. The input device of claim 6, wherein the device further comprises means for displaying the sign being input during said movement of the cursor/pointer.

10. A method for inputting at least one sign, comprising steps for moving a cursor/pointer implemented by a user in an input space, and steps for interpreting said movements in order to associate sets of movements with corresponding signs, wherein the input space comprises a base zone and from two to seven peripheral zones and wherein the inputting of each sign comprises:
a step for moving the cursor/pointer from the base zone to a first peripheral zone,
a step for moving the cursor/pointer from said first peripheral zone to a last peripheral zone,
a step for moving the cursor/pointer from said last peripheral zone to said base zone.

11. The input method of claim 10, wherein the input space comprises from three to seven peripheral zones, and wherein, for inputting certain signs, the step for moving the cursor/pointer from said first peripheral zone to said last peripheral zone occurs through at least one intermediate peripheral zone.

12. The input method of claim 11, wherein for inputting some of said certain signs, the last peripheral zone is the first peripheral zone.

13. The input method of claim 10, wherein the input space comprises from four to seven peripheral zones, and wherein, for inputting some signs, the step for moving the cursor/pointer from said first peripheral zone to said last peripheral zone occurs through at least two intermediate peripheral zone.

14. The input method of claim 10, wherein the steps for moving the cursor/pointer are carried out in an essentially circular manner, either in a clockwise direction or in a counter-clockwise direction.

15. The input method of claim 10, wherein the input space comprises a touch-sensitive surface linked to said device, and the steps for moving a cursor/pointer are implemented on said touch-sensitive surface.

16. The input method of claim 14, wherein the inputting of several signs is carried out by one contact and several movements on the touch-sensitive surface.

17. The input method of claim 14, wherein inputting a space after inputting a sign is carried out by releasing the touch-sensitive surface after said inputting of a sign.

18. The input method of claim 10, wherein the interpreting means comprise a sign coding wherein each sign is associated with a given set of movements, and the coding is configured for rapid input.

19. The input method of claim 17, wherein the sign coding comprise sets of signs wherein each sign is in a peripheral zone corresponding to the first peripheral zone to be actuated for inputting said sign, on an edge corresponding to the direction of rotation between peripheral zones and in an order corresponding to a number of peripheral zones actuated after the first peripheral zone.

20. A computer program product designed to be loaded into the memory of a command unit comprising software code portions for carrying out the method of claim 10.
